(19) United States
(12) Patent Application Publication
(10) Pub. No.: US 2013/0180262 A1
(43) Pub. Date: Jul. 18, 2013

(54) GAS TURBINE ENGINE ACCESSORY GEARBOX

(71) Applicant: Hung Duong, Unionville, CT (US)

(72) Inventor: Hung Duong, Unionville, CT (US)

(21) Appl. No.: 13/352,369

(22) Filed: Jan. 18, 2012

(51) Int. Cl. F02C 7/36; B23P 11/00

(52) U.S. Cl. 60/802; 29/893

(57) ABSTRACT

An accessory gearbox for a gas turbine engine has a main gearbox housing for receiving a plurality of gears to drive a plurality of accessories. An input shaft has a first bevel gear at an outer end, and extends inwardly to transmit rotation to the plurality of gears. A tower shaft has a second bevel gear engaging the first bevel gear to in turn drive the input shaft. A tower shaft houses is fixed to the main gearbox housing. A method of removing a tower shaft is also disclosed.

### BACKGROUND OF THE INVENTION

This application relates to a gas turbine engine accessory gearbox, wherein the connection of a tower shaft drive to components in the gearbox is simplified.

Gas turbine engines are known, and typically include a compressor delivering compressed air into a combustion section. The air is mixed with fuel and burned in the combustion section, and products of this combustion pass downstream over turbine rotors, causing the rotors to rotate. The turbine rotors in turn drive the compressor.

A number of accessories are typically included with a gas turbine engine. As an example, electric generators, and various pumps for providing fuel, oil, hydraulics, etc., to the gas turbine engine are typically also driven by the turbine rotor. In addition, a starter is also typically provided to drive the gas turbine engine at startup. The starter, the several pumps, and the generators have all typically been included in an accessory gearbox, which is positioned outwardly of a core of the gas turbine engine.

Typically, a so-called tower shaft is driven by a turbine shaft, and in turn is connected to a gear within the accessory gearbox by a so-called layshaft. The layshaft typically extends parallel to an axis of rotation of the engine. The tower shaft is connected to drive the layshaft, and is received in a separate tower shaft housing. The layshaft is in its own housing, and extends into the accessory gearbox.

In this prior art, to remove the tower shaft for repair or replacement, one has necessarily needed to remove the accessory gearbox and the layshaft housing.

### SUMMARY OF THE INVENTION

In one featured embodiment, an accessory gearbox for a gas turbine engine includes a main gearbox housing receiving a plurality of gears to drive a plurality of accessories. An input shaft has a first bevel gear at an outer end, and extends inwardly to transmit rotation to the plurality of gears. A tower shaft has a second bevel gear engaging the first bevel gear to in turn drive the input shaft. A tower shaft housing for the tower shaft is fixed to the main gearbox housing.

In another embodiment, a portion of the tower shaft housing has an end cover which is removable to allow removal of the tower shaft without disassembling the main gearbox housing from an engine.

In another embodiment according to prior embodiment, the end cover supports an end of the tower shaft through a bearing, and is removable with the bearing, such that upon removal of the end cover and the bearing, the tower shaft may be removed.

In another embodiment according to the prior embodiment, the first bevel gear is on a side of the second bevel gear spaced away from the end of the tower shaft such that the second bevel gear is able to move away from the first bevel gear when the end cover has been removed.

In another embodiment, the tower shaft housing is formed integrally with the main gearbox housing.

In another embodiment, the input shaft extends along an axis which is non-parallel to a drive axis of a gas turbine engine which is to receive the accessory gearbox.

In another featured embodiment, a gas turbine engine includes a main engine housing, and an accessory gearbox including a main gearbox housing for receiving a plurality of gears to drive a plurality of accessories. An input shaft has a first bevel gear at an outer end, and extends inwardly to transmit rotation to the plurality of gears. A tower shaft has a second bevel gear engaging the first bevel gear to drive the input shaft. A tower shaft housing for the tower shaft is fixed to the main gearbox housing.

In another embodiment according to the prior embodiment, a portion of the tower shaft housing has an end cover which is removable to allow removal of the tower shaft without disassembling the main gearbox housing from said gas turbine engine.

In another embodiment according to the prior embodiment, the end cover supports an end of the tower shaft through a bearing, and is removable with the bearing, such that upon removal of the end cover and bearing, the tower shaft may be removed.

In another embodiment according to the prior embodiment, the first bevel gear is on a side of the second bevel gear spaced away from the end of the tower shaft such that the second bevel gear may move away from the first bevel gear when the end cover has been removed.

In another embodiment according to the prior embodiment, the input shaft extends along an axis which is non-parallel to a drive axis of the gas turbine engine.

In another embodiment according to the featured embodiment, the input shaft extends along an axis which is non-parallel to a drive axis of a gas turbine engine.

In a featured method embodiment, a tower shaft can be disassembled from a gas turbine engine by removing a cover from a housing that houses the tower shaft. The tower shaft has a bevel gear engaging a bevel gear of an input shaft. The tower shaft is removed from the housing without disassembling the housing from the gas turbine engine.

In another embodiment of the featured method, a bearing supports one end of the tower shaft, and is also removed.

In another embodiment of the prior embodiment, the end of the tower shaft is an end remote from a drive input to the tower shaft.

In another embodiment according to the prior embodiment, the first bevel gear is on a side of the second bevel gear spaced away from the end of the tower shaft such that the second bevel gear may move away from the first bevel gear once the end cover has been removed.

In another embodiment of the featured method, the input shaft extends along an angle that is non-parallel to a drive axis of the gas turbine engine.

These and other features of the invention would be better understood from the following specifications and drawings, the following of which is a brief description.

### BRIEF DESCRIPTION OF THE DRAWINGS

FIG. 1 schematically shows a prior art gas turbine engine.

FIG. 2 shows a prior art accessory gearbox.

FIG. 3 shows a drive relationship in the known gearbox.

FIG. 4 shows an embodiment of this application.

FIG. 5A shows another feature of this application.

FIG. 5B shows a disassembly step which can occur with this application.

### DETAILED DESCRIPTION

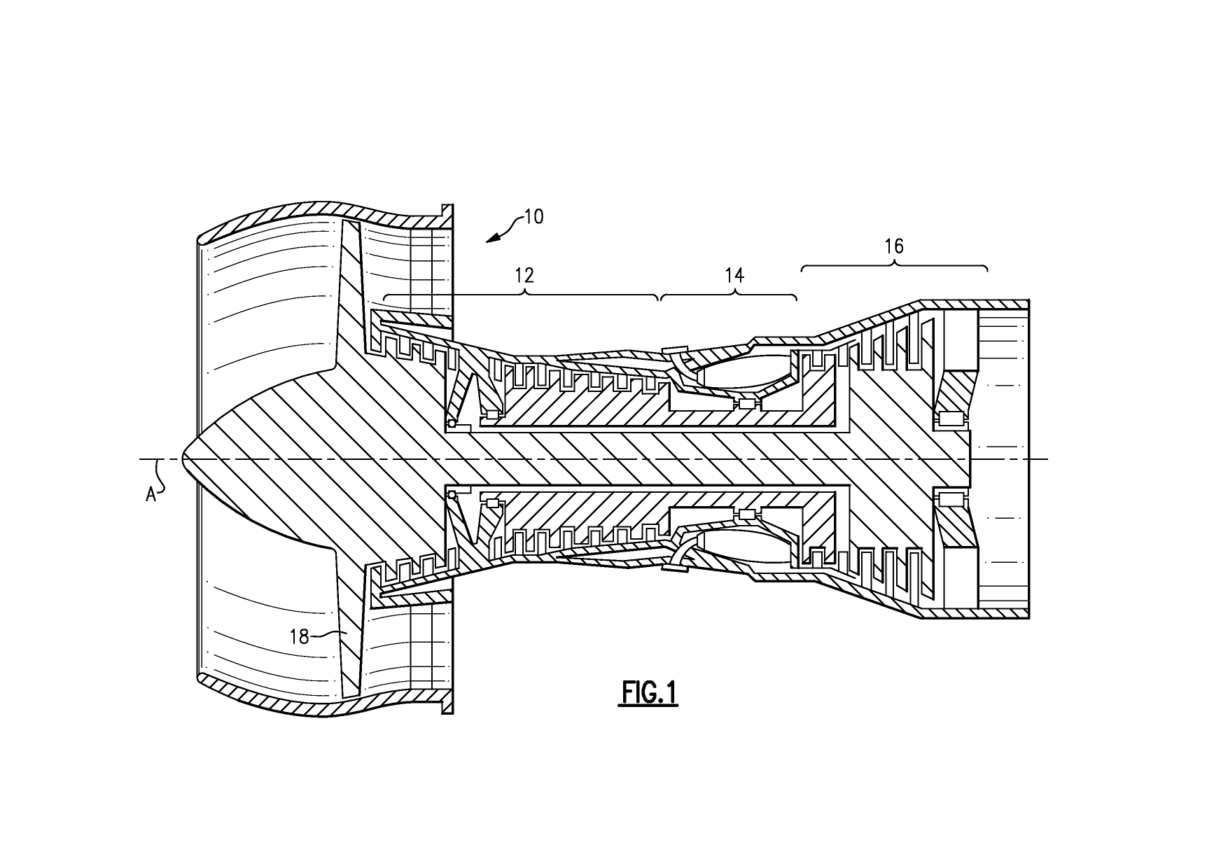

FIG. 1 shows a prior art gas turbine engine 10, such as a turbofan gas turbine engine, circumferentially disposed about an engine centerline A. The engine 10 includes a fan 18, a compressor 12, a combustion section 14 and turbine sections 16. As is well known in the art, air compressed in the compressor 12 is mixed with fuel and burned in the combustion section 14 and expanded across turbine sections 16. The turbines includes rotors that rotate in response to the expansion, driving compressor rotors and fan 18. This structure is shown somewhat schematically in FIG. 1. While one example gas turbine engine is illustrated, it should be understood this invention extends to any other type gas turbine engine for any application.

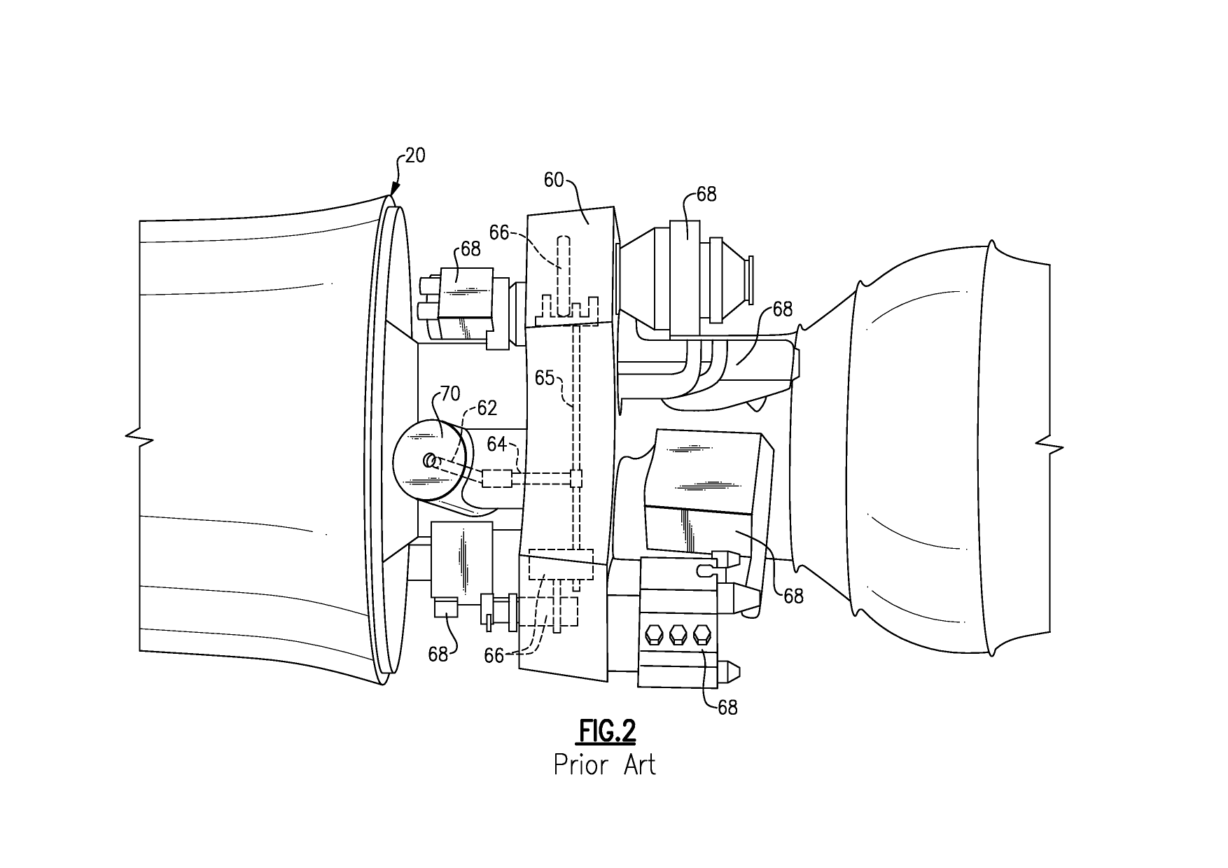

FIG. 2 shows an accessory gearbox 60 positioned beneath the engine housing 20. As known, a tower shaft 62 is driven by a turbine shaft, and drives a layshaft 64. The layshaft 64 in turn drives a gear 65 that drives a number of gears 66 within the accessory gearbox 60. Several accessories 68 are in turn driven by the gears 66. Among the accessories may be an oil pump, a fuel pump, a hydraulic pump, an alternator, an electrical generator, and a starter, as examples.

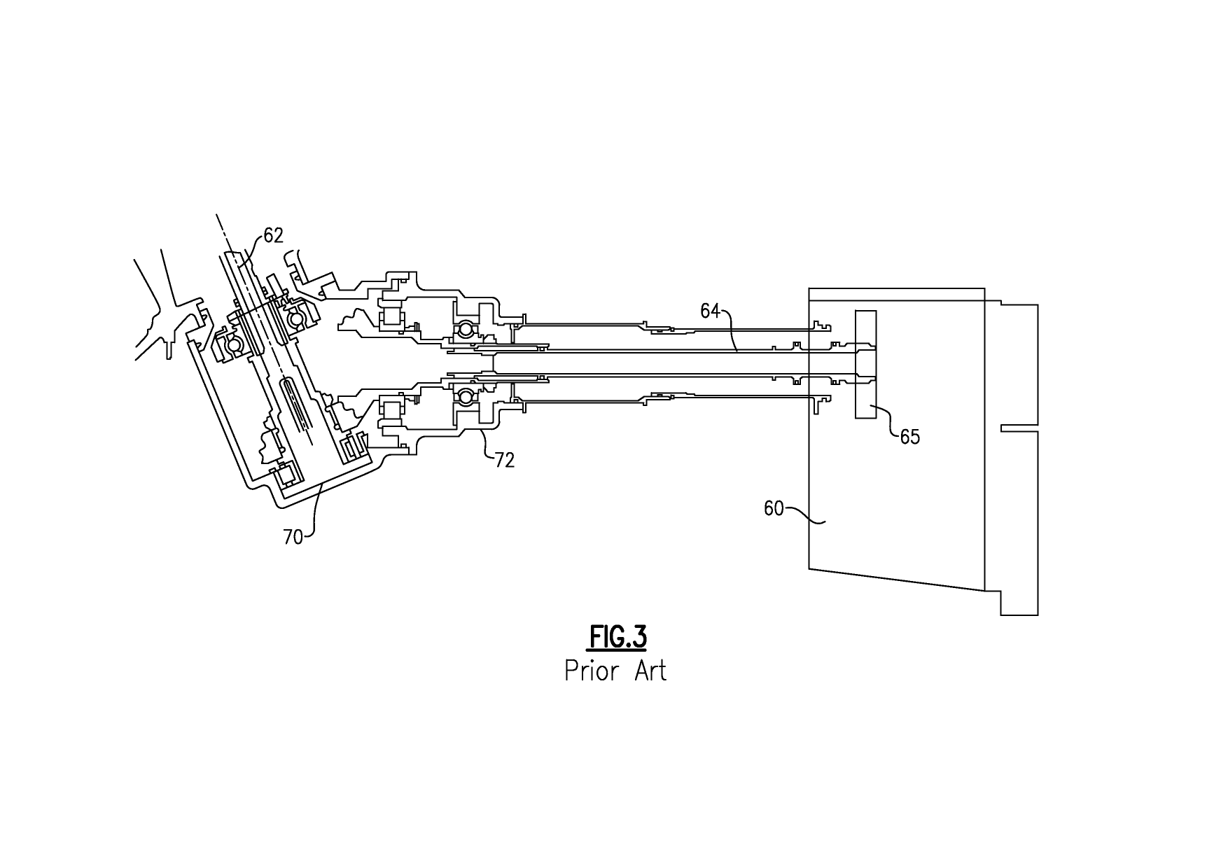

As shown in FIG. 3, the tower shaft 62 is mounted in a housing 70 which is removable from a housing 72 housing the layshaft 64. Layshaft 64 extends into the gearbox 60, to drive gear 65, and hence gears 66 (see FIG. 2). To remove the tower shaft 62, one has previously needed to remove the auxiliary gearbox 60, and the layshaft housing 72 along with the layshaft 64.

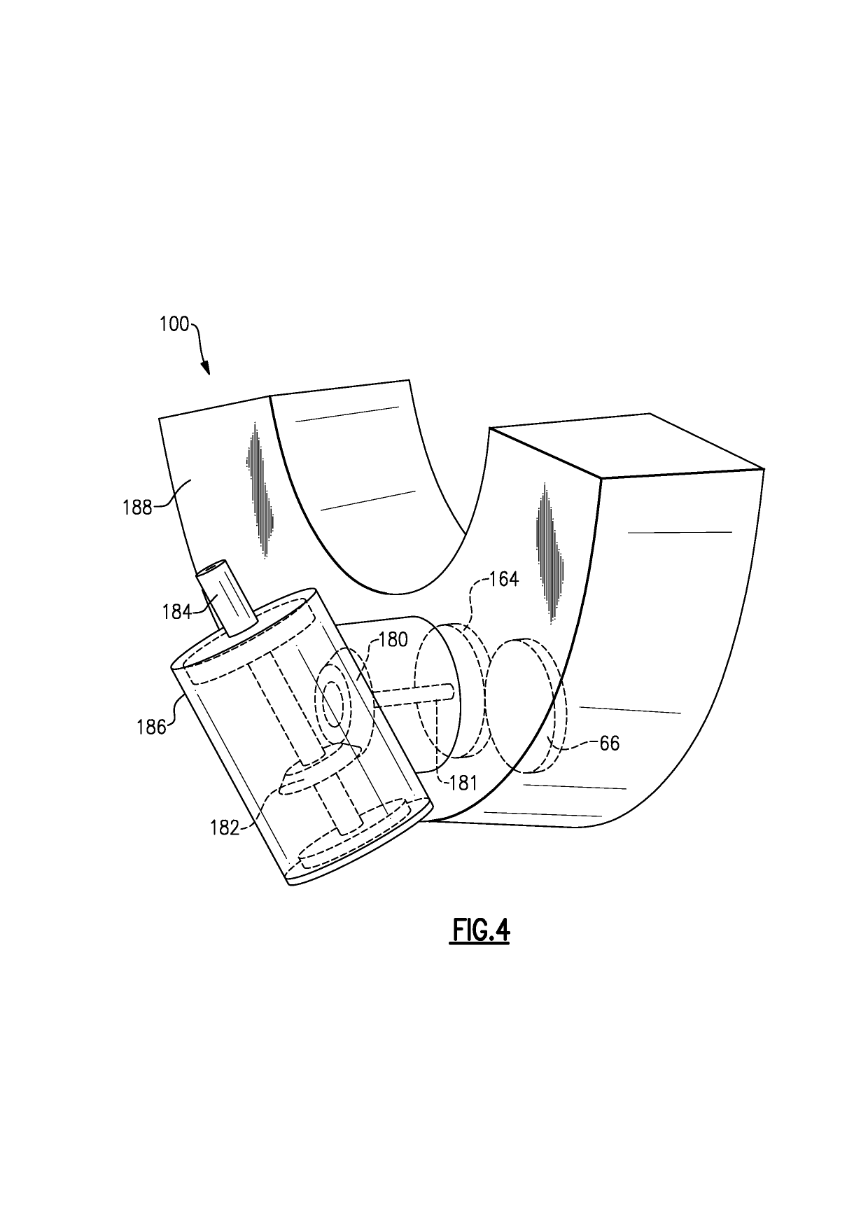

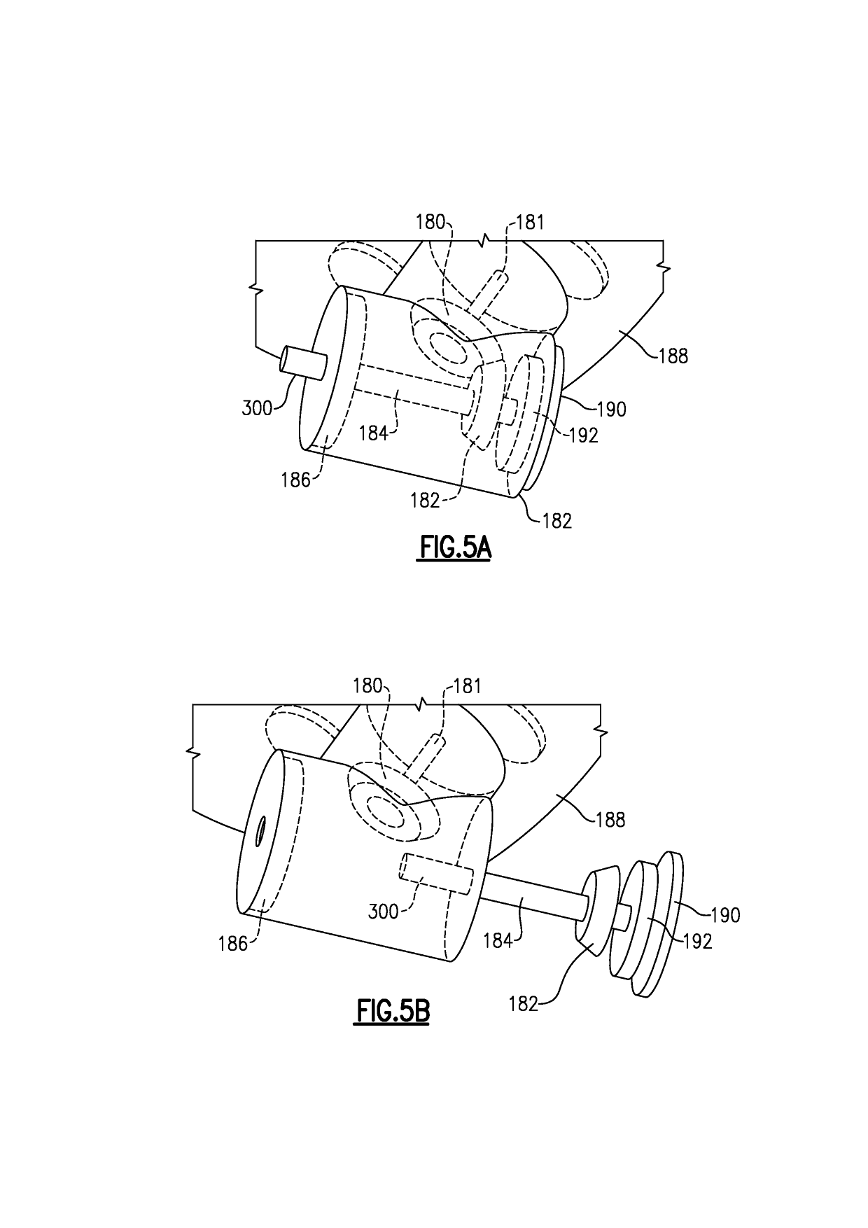

An embodiment 100 is shown in FIGS. 4, 5A and 5B. As shown in FIG. 4, a housing 188 now houses a bevel gear 180 which generally replaces the layshaft. The bevel gear 180 extends inwardly and drives a gear 164 through shaft 181. Gear 164 in turn drives the gears 66 associated with the accessories in a manner not unlike that of FIG. 2. However, the gear 180 extends along an axis which is not parallel to the drive axis of the engine, and thus the layshaft may be eliminated.

While the gear 180 as illustrated extends along an axis which is non-parallel to the drive axis of the engine, it can also be parallel. The disclosed arrangement simply provides more freedom with the regard to the positioning. The prior art arrangement with the several separate housings would have made it far too complex to have the axis not be parallel, and the disclosed arrangement provides the designer with the freedom of arranging the drive axis of the accessory box as would be indicated by other factors.

The tower shaft 184 engages a bevel gear 182 received within a housing 186. The housing 186 is formed integrally with the housing 188. As shown in FIG. 5A, the angle between the gears 180 and 182 may be selected and designed into the design of the combined housing 186 and 188. The shaft 184 is shown to extend at an angle which is non-parallel to the drive axis of the engine receiving the accessory gearbox 188. While the housing 186 may be formed integrally with the housing 188, it may also be cast or otherwise formed separately, and then the two housings 186 and 188 fixed together by some means (welding, for example).

As shown in FIG. 5A, an end cover 190 is bolted to a fixed portion of a bearing 192 which supports the shaft 184 for mounting the bevel gear 182. Another portion of the bearing is press-fit onto an end of the shaft 184 and supported in the fixed portion.

As shown in FIG. 5B, one may remove the end cover 190, the bearing 192, and shaft 184 for replacement or repair without removing the accessory gearbox at all.

As would be appreciated by a worker of ordinary skill in this art, an input to drive the tower shaft 184 comes into an upper end 300, such that the tower shaft 184 may be driven from a shaft extending to the turbine rotors, or a drive shaft driven by the turbine rotors. In addition, as is clear, the bevel gear 182 engages the bevel gear 180 on an opposed end of the tower shaft 184 such that upon removal of the cover 190, the bevel gear 182 may merely move away from the bevel gear 180.

The combination of the integral housing 186 and 188 reduces the number of parts, and simplifies assembly and disassembly.

Although embodiments of this invention have been disclosed, a worker of ordinary skill in this art would recognize that certain modifications would come within the scope of this invention. For that reason, the following claims should be studied to determine the true scope and content of this invention.

1. An accessory gearbox for a gas turbine engine comprises:
a main gearbox housing for receiving a plurality of gears to drive a plurality of accessories;
an input shaft having a first bevel gear at an outer end, and extending inwardly to transmit rotation to said plurality of gears;
a tower shaft having a second bevel gear engaging said first bevel gear to in turn drive said input shaft; and
a tower shaft housing for said tower shaft being fixed to the main gearbox housing.

2. The gearbox as set forth in claim 1, wherein a portion of said tower shaft housing has an end cover which is removable to allow removal of said tower shaft without disassembling said main gearbox housing from an engine.

3. The gearbox as set forth in claim 2, wherein said end cover supports an end of said tower shaft through a bearing, and is removable with the bearing, such that upon removal of said end cover and said bearing, said tower shaft may be removed.

4. The gearbox as set forth in claim 3, wherein said first bevel gear is on a side of said second bevel gear spaced away from said end of said tower shaft such that said second bevel gear may merely move away from said first bevel gear when said end cover has been removed.

5. The gearbox as set forth in claim 1, wherein said tower shaft housing is formed integrally with said main gearbox housing.

6. The gearbox as set forth in claim 1, wherein said input shaft extending along an axis which is non-parallel to a drive axis of a gas turbine engine which is to receive the accessory gearbox.

7. A gas turbine engine incorporating:
a main engine housing housing a compressor, combustor and a turbine, and an accessory gearbox mounted outwardly of said main engine housing; and
the accessory gearbox including a main gearbox housing for receiving a plurality of gears to drive a plurality of accessories;
an input shaft having a first bevel gear at an outer end, and extending inwardly to transmit rotation to said plurality of gears;
a tower shaft having a second bevel gear engaging said first bevel gear to in turn drive said input shaft; and
a tower shaft housing for said tower shaft being fixed to the main gearbox housing.

8. The engine as set forth in claim 7, wherein a portion of said tower shaft housing has an end cover which is removable to allow removal of said tower shaft without disassembling said main gearbox housing from said gas turbine engine.

9. The engine as set forth in claim 8, wherein said end cover supports an end of said tower shaft through a bearing, and is removable with the bearing, such that upon removal of said end cover and said bearing, said tower shaft may be removed.

10. The engine as set forth in claim 9, wherein said first bevel gear is on a side of said second bevel gear spaced away from said end of said tower shaft such that said second bevel gear may merely move away from said first bevel gear when said end cover has been removed.

11. The engine as set forth in claim 10, wherein said input shaft extending along an axis which is non-parallel to a drive axis of said the gas turbine engine.

12. The engine as set forth in claim 7, wherein said input shaft extending along an axis which is non-parallel to a drive axis of said gas turbine engine.

13. A method of disassembling a tower shaft from a gas turbine engine comprising the steps of:
removing a cover from a housing housing said tower shaft;
said tower shaft having a second bevel gear engaging a first bevel gear of an input shaft; and
then removing said tower shaft from said housing without disassembling said housing from the gas turbine engine.

14. The method as set forth in claim 13, wherein a bearing which supports one end of said tower shaft is also removed.

15. The method as set forth in claim 14, wherein said one end of said tower shaft is an end remote from a drive input to said tower shaft.

16. The method as set forth in claim 15, wherein said first bevel gear is on a side of said second bevel gear spaced away from said end of said tower shaft such that said second bevel gear may merely move away from said first bevel gear when said end cover has been removed.

17. The method set forth in claim 13, wherein said input shaft extends along an angle that is non-parallel to a drive axis of the gas turbine engine.
